(19) United States
(12) Patent Application Publication
(10) Pub. No.: US 2026/0054951 A1
(43) Pub. Date: Feb. 26, 2026

(54) SPLICER FOR AN UNWINDER, UNWINDER COMPRISING THE SPLICER, AND CORRUGATED BOARD PRODUCTION LINE COMPRISING THE UNWINDER

(71) Applicant: FOSBER S.P.A., Pescaglia (IT)

(72) Inventors: Lorenzo VANNUCCHI, Pescaglia (IT); Marco IMPOSTI, Pescaglia (IT); Sauro RUBERTI, Pescaglia (IT); Francesco PINNA, Pescaglia (IT)

(73) Assignee: FOSBER S.P.A., Pescaglia (IT)

(21) Appl. No.: 19/297,157

(22) Filed: Aug. 12, 2025

(30) Foreign Application Priority Data
Aug. 20, 2024 (IT) 102024000019078

(51) Int. Cl. B65H 19/18; B65H 19/10

(52) U.S. Cl. CPC B65H 19/1842; B65H 19/102; B65H 2301/46171; B65H 2301/46332; B65H 2701/1762

(57) ABSTRACT

The splicer, for splicing a first web material and a second web material, comprises a retaining device adapted to hold a leading edge of the second web material in a standby position; and a dispenser for an adhesive, comprising a dispensing member configured to dispense a strip of adhesive onto the leading edge of the second web material in the standby position. An unwinder and a line are also disclosed, using splicers as defined above, as well as a method for splicing two web materials together.

### TECHNICAL FIELD

The present invention relates to lines for the production of corrugated board and the like, as well as to parts thereof.

### BACKGROUND ART

For producing corrugated board, complex production lines are used, which produce a continuous web material consisting of at least two continuous webs of smooth paper, so-called “liners,” between which at least one continuous fluted paper web, glued to the liners, is interposed. Some lines also comprise machines that divide the continuous corrugated board web into longitudinal strips and then divide the longitudinal strips into sheets that are stacked for later shipment to the end user.

The corrugated board production lines comprise one or more single facers, each of which is fed with two continuous paper webs, one of which is corrugated between two corrugating rollers and glued to a smooth paper web, to form a web of single-face corrugated board. In some production lines, one or more webs of single-face corrugated board are fed to a double facer, where the webs of single-face corrugated board are glued together and to a second liner or smooth paper web.

The operation of the production line must be continuous, as shutdowns and restarts of the production line would result in cooling and successive heating of the various line members, or in overheating of parts of the corrugated board, or the paper forming it, which can result in damages to the machines or in the production of defective corrugated board.

The continuous operation requires the use of splicers for splicing paper webs coming from unwinding stations of the unwinders interfaced to the line machines. The splicers are used to splice together a paper web coming from an empty reel in a first unwinding station, and a paper web coming from a new, standby reel positioned at a second unwinding station.

The leading edge of the web of the standby new reel is prepared in the splicer and provided with a strip of double-sided adhesive to splice together the web coming from the empty reel and the web coming from the standby new reel. The strip of double-sided adhesive is supplied from a reel of double-sided adhesive tape, which consists of a substrate, typically a strip of paper, to the two faces of which a pressure-sensitive adhesive is applied. The two layers of the pressure-sensitive adhesive are protected by strips of protective material. The protective material is removed before the double-sided adhesive is applied to the leading edge of the standby paper web.

The use of double-sided adhesive tapes is complex and expensive, and involves drawbacks related to the cost of the material. In addition, the paper and the protective strips of the double-sided adhesive tape are basically waste materials, which have a negative environmental impact. In addition, the double-sided adhesive requires, by its very nature, the use of a double layer of pressure-sensitive adhesive, and therefore a high consumption of polluting and expensive material.

Therefore, it would be useful to provide a splicer, which overcomes, completely or partially, the drawbacks of the prior art.

### SUMMARY OF THE INVENTION

According to an aspect, a splicer is disclosed herein, comprising a retaining device adapted to hold a leading edge of a web material coming from a standby reel, and a dispenser for an adhesive, comprising a dispensing member configured to dispense a strip of adhesive onto the leading edge of the second web material in the standby position.

Specifically, in some embodiments described herein, the dispensing member is adapted to dispense a bulk adhesive, for example in liquid or pasty form. The adhesive may be a hot melt adhesive.

The splicer according to the invention does not use a double-sided adhesive tape, as is the case with conventional splicers, but instead applies the glue or adhesive, typically in liquid or pasty form, and generally in bulk form, distributing it directly onto the web material. This, on the one hand, reduces the amount of adhesive required, and, on the other hand, avoids the need for a double-sided adhesive support and adhesive protection films, which together constitute a consumable, polluting, and expensive material.

In some embodiments disclosed herein, the adhesive dispensing member is supported by a slide provided with a movement transverse to the feed direction of the web material through the splicer. For example, the splicer may comprise a guide transverse to the feed direction of the web material through the splicer, and a drive actuator adapted to translate the slide along the transverse guide.

In some embodiments, the slide carries a cutting member adapted to trim the leading edge of the web material through a movement of the slide along the transverse guide. This allows a trimming operation to be performed.

According to a further aspect, an unwinder is disclosed herein for unwinding web material wound in reels, comprising: a first unwinding station, a second unwinding station, and a splicer as defined above configured to splice a first web material, coming from a first reel arranged in the first unwinding station, and a second web material, coming from a second reel arranged in the second unwinding station.

According to a further aspect, a corrugated board production line is disclosed herein, comprising a first unwinder, having a first unwinding station and a second unwinding station, and a splicer as defined above to splice a depleted web material, coming from one of the first unwinding station and second unwinding station, and a leading edge of a web material, in standby within the splicer and coming from the other of the first unwinding station and second unwinding station.

The line may also comprise a second unwinder, having a first unwinding station and a second unwinding station, and an additional splicer as defined above, to splice a depleted web material, coming from one of the first unwinding station and second unwinding station of the second unwinder, and a leading edge of a web material, in standby within the splicer and coming from the other of the first unwinding station and second unwinding station of the second unwinder.

The line may also comprise a single facer, which is fed with a web material coming from the first unwinder and with a web material coming from the second unwinder.

The line may also comprise a double facer configured to receive a single-face corrugated board, coming from the single facer, and an additional web material, coming from a third unwinder, wherein the third unwinder preferably comprises a first unwinding station and a second unwinding station, and a third splicer as described above, to splice a depleted web material, coming from one of the first unwinding station and second unwinding station of the third unwinder, and a leading edge of a web material, in standby within the splicer and coming from the other of the first unwinding station and second unwinding station of the third unwinder.

According to a further aspect, a method is also disclosed for splicing a first web material, coming from an empty reel, and a leading edge of a second web material, coming from a second, standby reel; wherein the method comprises the following steps: (a) arranging the leading edge of the second web material in a preparation position; (b) applying an adhesive onto the leading edge, transversely to a feed path of the web material; (c) pressing the first web material onto the leading edge of the second web material, causing the first web material and the second web material to adhere to each other; (d) cutting the first web material downstream of the adhesive strip, thus generating a tail edge of the first web material; and (d) dragging, through the tail edge of the first web material, the second web material into a feed path.

Further advantageous features and embodiments of what described herein are illustrated below and are defined in the appended claims.

### BRIEF DESCRIPTION OF THE DRAWING

The invention will be better understood by following the description below and the accompanying drawing, showing a non-limiting embodiment of the invention.

### More Particularly, in the Drawing:

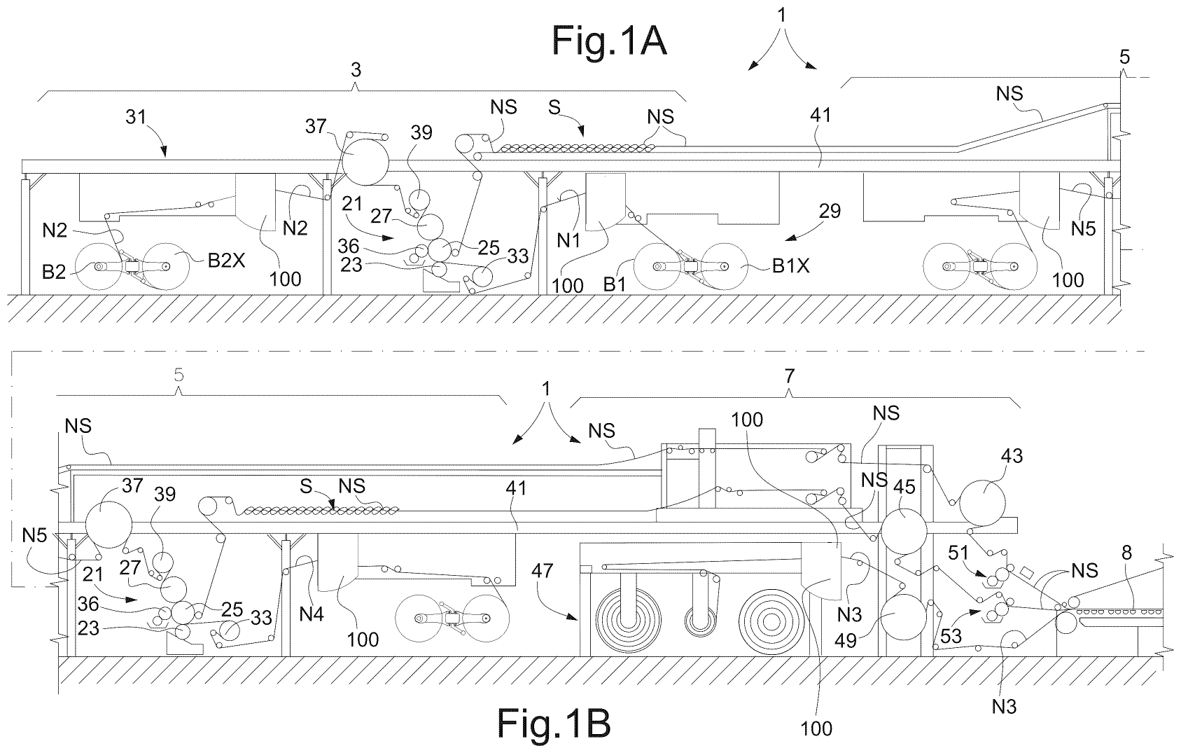

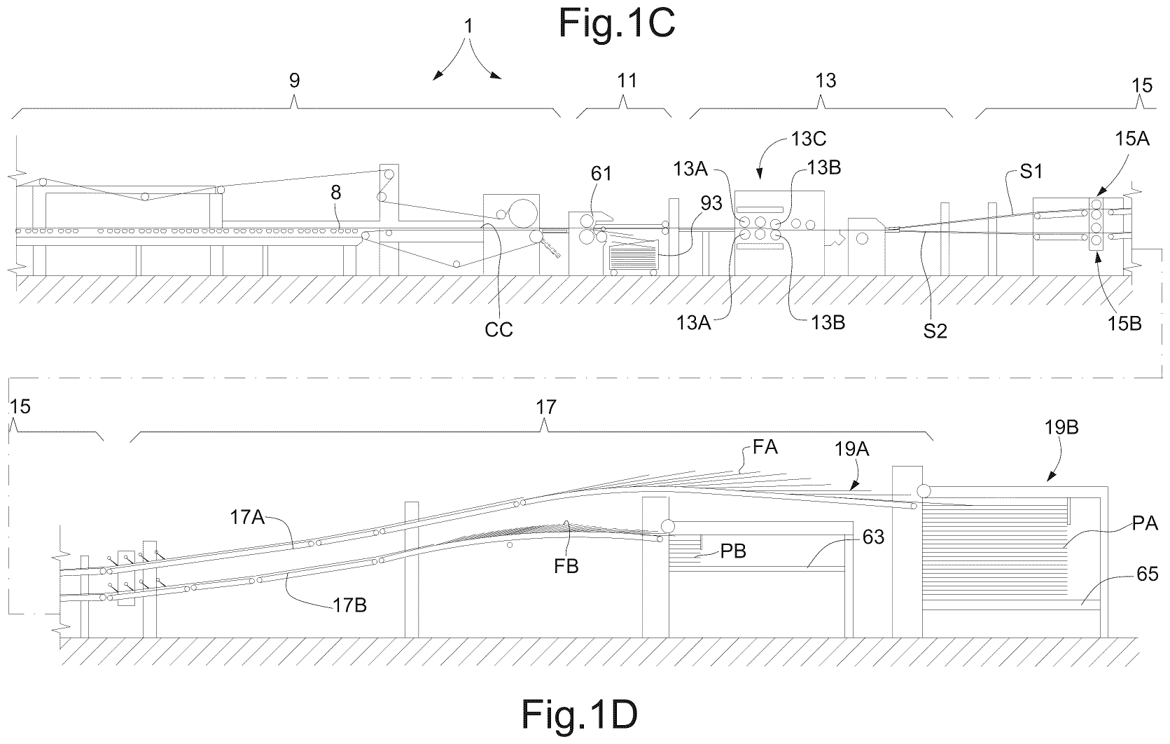

FIGS. 1A, 1B, 1C, and 1D schematically illustrate a corrugated board production line, in which one or more splicers according to the invention may be used;

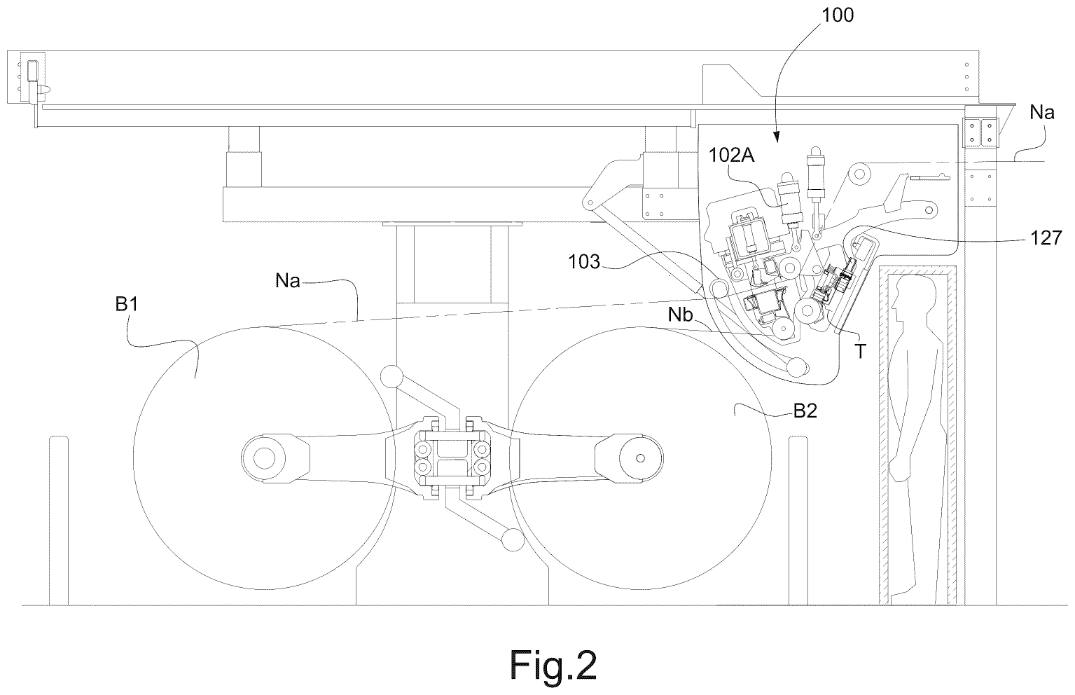

FIG. 2 shows an enlargement of an unwinder with a splicer;

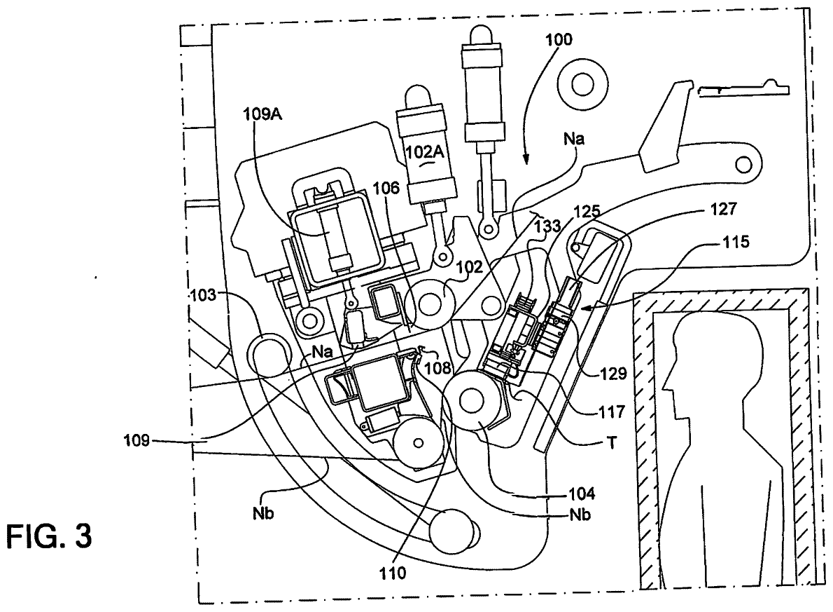

FIG. 3 shows an enlargement of the splicer of FIG. 2;

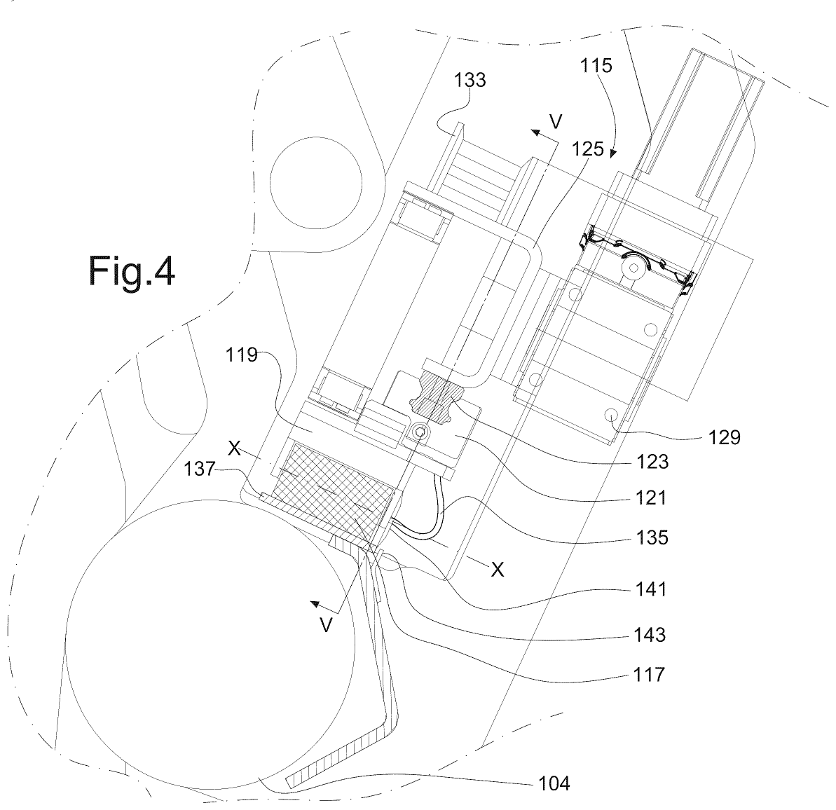

FIG. 4 shows an enlarged detail of FIG. 3; and

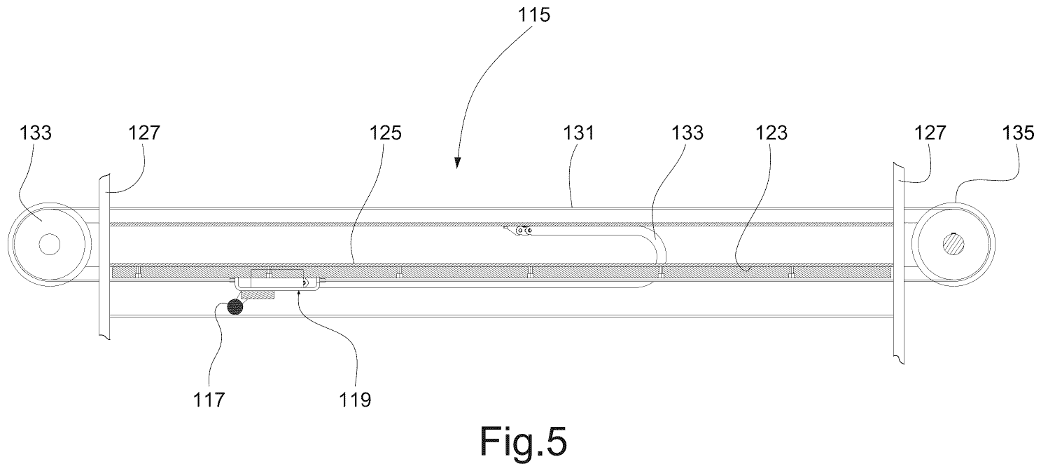

FIG. 5 shows a view according to V-V of FIG. 4.

### DETAILED DESCRIPTION

In the accompanying drawing, with specific reference to FIGS. 1A, 1B, 1C, and 1D, the reference numeral 1 generically indicates as a whole a plant for manufacturing adequately creased sheets of corrugated board from continuous webs of smooth paper.

In the illustrated embodiment, the plant provides for the production of sheets of double wall corrugated board, i.e. with two webs of fluted paper interposed between two webs of smooth paper, so-called liners, and a web of smooth paper interposed between the two fluted paper webs. Moreover, the plant is configured to form two piles of sheets on two adjacent stackers.

The general structure of the plant is similar to that disclosed in WO 2017/0366685 or WO 2021005123A1. However, the various sections and machines constituting the plant can be even arranged in a substantially different manner than that illustrated in the disclosed embodiment. For example, the plant can have the structure described in EP 3678859 or in DE 10201000890.

With reference to the illustrated embodiment, the plant 1 comprises a first section 3, for the production of a first web NS of single-face corrugated board, a second section 5 for the production of a second web NS of single-face corrugated board, a third section 7 for feeding the two webs of single-face corrugated board and a web of smooth paper to a double facer 8, a section 9 comprising the double facer 8 and the corresponding accessories. From section 9 a double wall corrugated board CC exits, formed by the set of the webs NS of single-face corrugated board and the web of smooth paper glued thereto, the smooth paper web forming a second liner of the corrugated board web.

A converting system is provided downstream of section 9 to convert the corrugated board web CC into single sheets of one or more distinct production orders or batches. In general, the converting system comprises longitudinal and transverse cutting systems as well as longitudinal scoring systems for cutting the corrugated board web CC into strips, scoring the strips and cutting the various strips into separate sheets.

In the illustrated embodiment, the converting system comprises the following members. Downstream of the double facer 8, a section 11 is provided, where devices are arranged for removing trimmings and perform order changes, and downstream of section 11, a section 13 is provided for longitudinally cutting and scoring the corrugated board CC coming from the section 9 containing the double facer 8, in order to divide the corrugated board web into a plurality of longitudinal strips of corrugated board.

Moreover, the plant 1 comprises a section 15 for transversely cutting the corrugated board strips coming from section 13, a double conveyor 17 and, lastly, two stacking areas or stackers 19A and 19B for stacking the board sheets cut in section 15 and fed by means of the double conveyor 17.

In section 3, a first corrugator 21 is arranged. Corrugators usable for producing a web of single-face corrugated board are known in se. Only the main elements of the corrugator will be described hereunder, the corrugator being for example as that disclosed in U.S. Pat. No. 8,714,223 or in EP 1362691, whose content is incorporated in the present description.

Briefly, the corrugator 21 comprises a first corrugating roller 23 co-acting with a second corrugating roller 25 and a pressure roller 27, or other pressure member, to bond a web of smooth paper and a web of fluted paper together. More in particular, a first web N1 of smooth paper is fed to the corrugator 21 from a first unwinder 29. The unwinder 29 can be configured in a known fashion, thus it will not be described in detail. The unwinder 29 may comprise two or more positions for a first unwinding reel B1, from which the first smooth paper web N1 is supplied, and a second, standby reel B1X, which will be unwound when the reel B1 is empty.

A second web N2 of smooth paper is unwound from a second unwinder 31, which may be substantially identical to the unwinder 29, and onto which a first reel B2, from which the smooth paper web N2 is unwound, and a second, standby reel B2X are arranged, the standby reel B2X starting to be unwound when the reel B2 is depleted.

The first smooth paper web N1 is fed to the corrugating roller 23, after being routed around a heating roller 33. The wrap angle of the smooth paper web N1 around the heating roller 33 may be adjusted in order to transfer to the smooth paper web N1 a greater or lower amount of heat coming from inside the heating roller 33 or a heating plate, heated for example by steam circulating therein.

The first smooth paper web N1 is fluted passing through the nip formed between the corrugating rollers 23 and 25. By means of an application roller 36 of a gluing unit, a suitable glue is applied to the crests formed on the fluted paper web, so that the fluted paper web N1 can be glued onto the smooth paper web N2 fed, together with the fluted paper web N1, through the nip formed between the second corrugating roller 25 and the pressure roller 27.

The application roller is in contact with the crests of the fluted paper web N1 driven around the second corrugating roller 25. The application roller 36 receives the glue from a tank or the like.

In some embodiments, the second smooth paper web N2 is routed around one or more heating rollers or plates 37, 39 positioned between the unwinder 31 and the corrugator 21, in order to be heated. The wrapping angle between the smooth paper web N2 and any one or both of the rollers 37, 39 can be modified in order to vary the amount of heat transferred by the roller(s) 37, 39 to the smooth paper web N2 before it comes into contact with the pressure roller 27. Also the pressure roller can be heated internally to glue the paper webs N1 and N2 in conditions of high pressure and high temperature.

Instead of, or in combination with, heating rollers, heating plates can be provided.

At the output of the corrugator 21, a single-face corrugated board web NS is obtained, formed by the first fluted paper web N1 and the second smooth paper web N2. The flutes O formed on the first fluted paper web N1 are glued, by means of a glue applied by the gluing unit to the flutes O of the fluted paper web N1, onto the surface of the smooth paper web N2 facing the fluted paper web N1.

Both the first unwinder 29 and the second unwinder 31 comprise a splicer, schematically indicated by the reference numeral 100 for both the unwinders. The splicer 100 is typically comprises multiple components, schematically shown in the figure, that can take variable mutual positions based on which reel is being processed and which is in standby. In general, the splicer can be configured as disclosed in US2017/0291784, and may have innovative features, which will be described in more detail below and specifically form part of the present disclosure.

These innovative features can also be implemented in splicers with different configurations. Examples of different splicers that can be used are disclosed in U.S. Pat. Nos. 7,441,579; 6,966,961.

Downstream of the corrugator 21 a bridge 41 is provided, which extends towards the section 5 and the following sections 7 and 9 of the plant 1. A stock S of single-face corrugated board web NS may be formed on the bridge 41. The web of single-face corrugated board NS is then fed along a first path, which extends above the bridge 41 up to a heating roller 43 or other heating system, around which the single-face corrugated board NS can be routed for an adjustable angle, to be appropriately heated before reaching the double facer 8 of the section 9.

In the illustrated embodiment, the plant 1 comprises a second section 5 substantially equal to the section 3, where a second single-face corrugated board web, still indicated with NS, is formed by means of a further pair of paper webs N4, N5 coming from unwinders similar to the unwinders 29 and 31 and a corrugator similar to the corrugator 21. The second single-face corrugated board web NS is fed to the bridge 41 to form a stock S and to be fed towards the double facer 8 of the section 9, being routed around a heating roller 45 or other heating member, substantially equivalent to the heating roller 43. In other embodiments, the section 5 can be omitted, as well as the respective corrugator. In further embodiments, more than two sections 3, 5 may be provided, with respective the corrugator and unwinder for corrugating and unwinding the paper web to form respective single-face corrugated board webs NS, which are then glued together by means of the double facer 8 of section 9.

A smooth paper web N3 is unwound from a further unwinder 47, provided with a splicer indicated again with the reference numeral 100, and is fed, preferably routed around a heating roller 49 or other heating member, to the section 9 of the double facer 8. In a known manner, gluing units 51, 53 apply a glue to the crests of the respective single-face corrugated board web NS, to glue them together and to the smooth paper web N3, which will form the second outer liner of the corrugated board CC coming out from section 9, the first outer liner being formed by the smooth paper web N2.

The section 9 containing the double facer 8 can be constructed in a manner known known in the art and will not be described in detail herein.

In section 11, a rotary slitter or other slitting member 61 is provided, which can perform transverse cuts to sever, completely or only partially, the corrugated board CC fed from section 9. The rotary slitter 61 can be especially used to discharge portions of corrugated board CC where gluing defects or other defects are detected, as well as to co-act in the format change sequence. In particular, the rotary shear is adapted to make intermediate transverse cuts in the corrugated board, so as to connect with one another longitudinal strips of consecutive orders in the order change area.

In the illustrated embodiment, the corrugated board CC, fed through the cutting and scoring section 13, is divided into strips, which can be deviated along two paths defined by the two conveyors 17A, 17B of section 17, at different heights. In general, the cutting and scoring section 13 can comprise one or more slitter-scorers 13C that, in addition to longitudinally cut the corrugated board web CC into longitudinal strips, can generate side trimmings and form scoring lines. To this end, the slitter-scorer 13C can comprise one or more series of longitudinal scoring tools 13A and one or more series of longitudinal cutting tools 13B. Analogously, each series of longitudinal cutting tools can comprise a plurality of longitudinal cutting tools adapted to be arranged in suitable positions along a transverse direction relative to the feed direction of the corrugated board CC through the plant 1.

The two conveyors 17A, 17B transport corrugated board sheets obtained by transversely cutting the continuous strips in section 15 in order to form stacks PA, PB on stacking planes 63, 65. In the illustrated embodiment, the section 15 comprises two cut-off knife 15A and 15B, configured to divide longitudinal strips S1, S2 into single sheets FA, FB. A variable number of strips can be fed to each cut-off knife 15A, 15B, based on the overall number of strips into which the corrugated board web CC has been divided by the slitter scorer 13C and on the ways they are distributed toward the two conveyors 17A, 17B.

As mentioned above, each unwinder of the line 1 comprises two unwinding stations, for two reels that are unwound sequentially. While in one of the two unwinding stations a reel is unwound and feeds a web material to the line 1, in the other unwinding station a new reel is loaded, which will replace the reel being unwound when depleted. To this end, each unwinder comprises a respective splicer 100, which can have various configurations. The embodiment illustrated for the splicers of the line 1 is purely illustrative. It should be understood that the splicers may be different from the one described herein. It is also possible to use, for the various unwinders, splicers that differ in shape and operation, if this is convenient or appropriate.

In the illustrated embodiment, the splicer 100 is generally constructed as disclosed in detail in US2017/0291784, which can be referred to for more details. Therefore, the elements of the splicer 100 will not be described, unless it is necessary to understand the innovative elements of the present invention, as the general structure of the splicer is known and in any case is not binding. The innovative elements described herein can be incorporated, for example, in the splicers disclosed in EP1422175, EP1609749, as well as in other splicers known to those skilled in the art.

In the illustrated embodiment (see especially FIG. 3), the splicer 100 comprises guide rollers 102, 103, which guide the web material being fed, whilst a leading edge T of a second web material is positioned in a standby position to be joined to the tail edge of the fed web material upon depletion of the reel from which the fed web material is unwound. Since FIG. 3 refers to any of the splicers schematically illustrated in FIG. 1, the web materials illustrated in FIG. 3 can be those coming from the reels in the two unwinding stations of any of the unwinders of FIG. 1. Therefore, in FIG. 3, the first web material (being fed) is generically indicated by the reference Na, and the second web material (in standby) is indicated by the reference Nb.

The splicer 100 also comprises a pinching member that includes an element transverse to a feed direction of the web material Na, Nb. In the illustrated embodiment, the transverse element comprises (or consists of) a pinching roller 104 co-acting with an anvil surface 110 that defines a pinching stop. The pinching member, and specifically the transverse element 104 thereof, is movable toward the pinching stop to hold the leading edge of the second web material Nb when this latter has been provided with a layer of adhesive, as described below. The elements 110 and 104 constitute a retaining device adapted to hold the leading edge of the second web material Nb.

The reference numeral 106 indicates a cutting device, specifically a cutting blade that co-acts with an anvil blade 108 to cut the web material Na when this latter is substantially depleted and has been spliced to the web material Nb, as disclosed in detail in US2017/0291784.

Characteristically, the splicer 100 comprises an adhesive dispenser 115, configured to dispense a strip of adhesive onto the leading edge T of the second web material Nb. The adhesive dispenser 115 is illustrated in detail in FIGS. 3, 4, and 5. The adhesive strip is continuous and has constant width, but this is not strictly essential. In some embodiments, the strip is discontinuous and/or has a particular pattern, according to the specific needs of the production line, for example in order to reduce adhesive consumption. In some embodiments, the adhesive dispenser is configured to apply the adhesive discontinuously, thereby reducing adhesive consumption, and thus the costs and the pollution resulting from dispensing unnecessary amounts of adhesive.

In some embodiments, the adhesive dispenser has adjustable systems adapted to vary the amount of adhesive applied to the web material.

The adhesive dispenser 115 is configured to dispense bulk adhesive, particularly in liquid or pasty form, in contrast to the prior art splicers, where the adhesive is applied in the form of a double-sided adhesive tape.

In the illustrated embodiment, the adhesive dispenser is configured to apply an adhesive in liquid or pasty form by means of a dispensing member movable in a direction transverse to the feed direction of the web material Na and Nb, i.e. in a direction orthogonal to the plane of the figures.

In the illustrated embodiment, the dispensing member comprises a dispensing roller 117 adapted to apply adhesive to the surface, facing the dispensing roller 117, of the leading edge T of the second web material Nb. The dispensing roller 117 is rotatable around an axis X-X, and is carried by a slide 119. The slide 119 is coupled, through a shoe 121, to a guide 123 transverse to the feed direction of the web material Na, Nb. The guide is supported by a beam 125, fastened to flanks 127 (see FIG. 5) of the splicer 100.

In other embodiments, the adhesive dispensing member comprises elements other than a roller. For example, the dispensing member may comprise a doctor blade, a nozzle, or a combination of the dispensing members mentioned herein.

The reference numeral 129 indicates an actuator, such as an electric motor, carried by the beam 125, for example, that provides motion to the slide 119. For example, the motion is transmitted to the slide 119 by a continuous flexible member 131, driven around two pulleys 133, 135 (see FIG. 5), one of which is driven in rotation by the motor 129. To this end, the slide 119 is attached to one of the branches of the continuous flexible member 131. The reference numeral 133 indicates a flexible guide for the passage of cables and/or conduits to the slide 119, for example to feed the liquid adhesive to the dispensing member. A flexible conduit 135, feeding the liquid adhesive to an inner chamber of the dispensing roller 117, is shown in FIG. 4. The dispensing roller may have a cylindrical pervious wall, through which the liquid adhesive can leak. To this end, the adhesive may be supplied inside the dispensing roller 117 at a suitable pressure, which can be higher the higher the viscosity of the adhesive.

The pressure can be adjusted according to the amount of adhesive to be applied, for example according to the amount of adhesive per cm².

Other dispensing members, for example nozzles or the like, can be used for dosing the amount of adhesive. For example, the adhesive can be intermittently dispensed through a nozzle, to dispense a discontinuous strip of adhesive, according to the specific need of the moment, for example depending on the type of material, i.e. the type of paper used.

In some embodiments, the adhesive is metered using a dispensing roller and a doctor blade co-acting with the dispensing roller.

In some embodiments, it is possible to reduce the amount of dispensed adhesive by means of a roller having a non-uniform dispensing surface, i.e. that does not dispense adhesive onto the entire width defined by the axial dimension of the dispensing roller.

In some embodiments, the cylindrical wall of the dispensing roller 117 is provided with uniformly distributed openings for the passage of the adhesive, so that the dispensing roller 117 dispenses a continuous strip of adhesive of constant width onto the web material. In other embodiments, the dispensing roller 117 may include a plurality of holes, apertures, or passageways, or may have a surface treatment configured to distribute the adhesive according to a desired pattern.

The dispensing roller 117, or other adhesive dispensing member of the adhesive dispenser 115, co-acts with an anvil member 137. In the illustrated embodiment, the anvil member 137 comprises a smooth surface transverse to the feed direction of the web material Na, Nb. The anvil member 137 is integral with the pinching member, in this case with the pinching roller 104. In other embodiments, the anvil member 137 is stationary relative to the flanks 127 of the splicer 100, and, for example, integral therewith.

In some embodiments, the adhesive dispenser is combined with a cutting member adapted to trim the leading edge of the web material, to which the adhesive is applied. The cutting member is advantageously carried by the slide 119, so that it can be operated by the same actuator 129 that controls the movement of the slide 119. In FIG. 4, the cutting member is indicated with the reference numeral 141 and is shaped like a disc blade, which is, for example, mounted idle on an axis parallel to the axis of the dispensing roller 117 or coincident with the axis X-X of the dispensing roller 117. The cutting member may also have a different shape and/or may be motorized. For example, the cutting member may comprise a motorized disc blade, a laser cutting system, a water cutting system, or other cutting systems or devices that can be used in this context. In the illustrated embodiment, the cutting member 141 co-acts with a counter blade 143 that may be integral with the anvil member 137.

The splicer 100 operates as follows. While the web material Na is fed toward the respective downstream machine, an operator puts the free edge, or leading edge, T of the web material Nb on the anvil member 137. In this step, the slide 119 is parked on a side of the splicer, near one of the flanks 127, so as not to interfere with the preparation of the leading edge.

Once the leading edge T has been positioned (FIG. 3), the slide 119 performs a transverse stroke, dispensing a strip of adhesive through the dispensing roller 117. During this stroke, the leading edge T is trimmed by means of the disc blade 141. In other embodiments, the adhesive is dispensed during a first transverse stroke of the slide 119, and the leading edge T is trimmed during a second transverse return stroke of the slide. In this case, the cutting member can be deactivated during the first stroke. To this end, for example, the cutting member may be supported by a movable arm bringing the cutting member away from the counter blade 143, in case the cutting member consists of a blade. If the cutting member consists of a different device, for example a laser or water device, it is sufficient to activate and deactivate the cutting member synchronously with the different strokes of the slide 119.

After the adhesive has been applied by the adhesive applicator 115, and after the free leading edge T has been trimmed if necessary, so that it has a minimum length beyond the adhesive band or strip deposited by the adhesive applicator, the pinching roller 104 is moved toward and pressed against the anvil surface 110, so that the free leading edge of the web material Nb is pinched and held in place until the cycle of splicing the web material Na and the web material Nb starts. Splicing is obtained by pressing the roller 102 and the roller 104 against each other, typically by pushing the roller 102 against the roller 104 by means of an actuator 102A (FIG. 3) and cutting the web material Na through the cutting blade 106 and the counter blade 108. A brake 109, actuated by an actuator 109A, locks the cut web material Na, while the pressure between the rollers 102 and 104, and the pull exerted by the tail of the web material Na, cause the start of the unwinding motion of the web material Nb, thanks to the movement of the pinching roller 104 away from the anvil surface 110.

In the illustrated embodiment, the splicer 100 is entirely arranged on one side of the unwinder, and the splicing cycle always takes place in the same position. Therefore, a single adhesive applicator is sufficient. In other known embodiments (see the publications cited above), the splicer comprises two separate splicing heads that are placed on opposite sides of the unwinder and work alternately depending on which of the two unwinding stations is in standby and which is working. In this case, two adhesive applicators are provided, one on each side of the unwinder.

For a more effective and safer adhesive application, the adhesive applicator may be associated with one or more sensors adapted to detect the presence and the correct positioning of the leading edge T of the second web material Nb. This ensures that the adhesive is dispensed only if the leading edge T of the second web material Nb is present and has been positioned correctly.

In some embodiments, locking members are provided for the leading edge T of the second web material Nb to prevent it from moving, particularly in the transverse direction, while the adhesive is dispensed. This function can be performed by mechanical and/or pneumatic locking systems, such as suction systems. For example, in some embodiments the anvil member 137 is sucking, for example it is part of a suction box. In other embodiments, a suction case or plane is provided, adjacent to the anvil member 137 and/or the counter blade 143.

What is claimed is:

1. A splicer for splicing a first web material and a second web material together; wherein the splicer comprises a retaining device adapted to hold a leading edge of the second web material in a standby position; and an adhesive dispenser, comprising a dispensing member configured to dispense a strip of adhesive onto the leading edge of the second web material in the stand position; wherein the retaining device comprises a pinching member for pinching the leading edge of the web material, the adhesive dispenser co-acting with the pinching member.

2. The splicer of claim 1, wherein the dispensing member is adapted to dispense bulk adhesive in liquid or pasty form.

3. The splicer of claim 1, wherein the adhesive is a hot melt adhesive.

4. The splicer of claim 1, wherein the pinching member comprises a transverse element transverse to a feed direction of the web material through the splicer; wherein the transverse element co-acts with a pinching stop; and wherein the pinching stop and the transverse element are movable relative to each other to clamp the leading edge of the second web material.

5. The splicer of claim 4, comprising an anvil member co-acting with the adhesive dispensing member integral with the transverse element of the pinching member.

6. The splicer of claim 1, wherein the adhesive dispensing member is supported by a slide provided with a movement transverse to the feed direction of the web material through the splicer.

7. The splicer of claim 6, comprising: a guide transverse to the feed direction of the web material through the splicer; and a drive actuator adapted to translate the slide along the transverse guide.

8. The splicer of claim 6, wherein the slide carries a cutting member adapted to trim the leading edge of the web material through a movement of the slide along the transverse guide.

9. The splicer of claim 8, wherein the cutting member is configured to co-act with a counter blade.

10. The splicer of claim 9, when dependent on at least claim 4 or 5, wherein the counter blade is integral with the pinching member.

11. The splicer of claim 1, comprising a cutting device adapted to cut the first web material after the first web material has been spliced to the leading edge of the second web material.

12. The splicer of claim 1, wherein the adhesive dispensing member comprises one or more of the following: an application roller; a doctor blade; an application nozzle.

13. The splicer of claim 1, wherein the adhesive dispensing member comprises an applicator roller, having an inner chamber connected to an outer cylindrical surface of the applicator roller through ports provided in a cylindrical wall of the applicator roller, and a supply duct for supplying adhesive into the inner chamber.

14. An unwinder, for unwinding web material wound in reels, comprising: a first unwinding station, a second unwinding station, and the splicer configured to splice a first web material, coming from a first reel arranged in the first unwinding station, to a second web material, coming from a second reel arranged in the second unwinding station;
and wherein the splicer comprises: a retaining device adapted to hold a leading edge of the second web material in a standby position; and an adhesive dispenser, comprising a dispensing member configured to dispense a strip of adhesive onto the leading edge of the second web material in the stand position; and wherein the retaining device comprises a pinching member for pinching the leading edge of the web material, the adhesive dispenser co-acting with the pinching member.

15. A corrugated board production line comprising a first unwinder, having a first unwinding station and a second unwinding station, and a splicer, to splice a depleted web material, coming from one of said first unwinding station and second unwinding station, to a leading edge of a web material, in standby in the splicer and coming from the other of said first unwinding station and second unwinding station;
wherein the splicer comprises: a retaining device adapted to hold a leading edge of the second web material in a standby position; and an adhesive dispenser, comprising a dispensing member configured to dispense a strip of adhesive onto the leading edge of the second web material in the stand position; and wherein the retaining device comprises a pinching member for pinching the leading edge of the web material, the adhesive dispenser co-acting with the pinching member.

16. The line of claim 15, further comprising a second unwinder, having a first unwinding station and a second unwinding station, and an additional splicer, to splice a depleted web material, coming from one of said first unwinding station and second unwinding station of the second unwinder, to a leading edge of a web material, in standby in the splicer and coming from the other of said first unwinding station and second unwinding station of the second unwinder;
wherein the additional splicer comprises: a retaining device adapted to hold a leading edge of the second web material in a standby position; and an adhesive dispenser, comprising a dispensing member configured to dispense a strip of adhesive onto the leading edge of the second web material in the stand position; wherein the retaining device comprises a pinching member for pinching the leading edge of the web material, the adhesive dispenser co-acting with the pinching member.

17. The line of claim 16, comprising a single facer, which is fed with a web material coming from the first unwinder and with a web material coming from the second unwinder.

18. The line of claim 17, further comprising a double facer configured to receive a single-face corrugated board, coming from the single facer, and an additional web material, coming from a third unwinder, wherein the third unwinder preferably comprises a first unwinding station and a second unwinding station, and a third splicer, to splice a depleted web material, coming from one of said first unwinding station and second unwinding station of the third unwinder, to a leading edge of a web material, in standby in the splicer and coming from the other of said first unwinding station and second unwinding station of the third unwinder;
wherein the third splicer comprises: a retaining device adapted to hold a leading edge of the second web material in a standby position; and an adhesive dispenser, comprising a dispensing member configured to dispense a strip of adhesive onto the leading edge of the second web material in the stand position; wherein the retaining device comprises a pinching member for pinching the leading edge of the web material, the adhesive dispenser co-acting with the pinching member.

19. A method for splicing a first web material, coming from an empty reel, to a leading edge of a second web material, coming from a second, standby reel;
wherein the method comprises the following steps:
arranging the leading edge of the second web material in a preparation position;
applying an adhesive onto the leading edge, transversely to a feed path of the web material, through an adhesive dispenser co-acting with a pinching member of a retaining device adapted to hold the leading edge;
holding the leading edge, with the adhesive applied thereto, by said pinching member;
pressing the first web material onto the leading edge of the second web material, causing the first web material and the second web material to adhere to each other;
cutting the first web material downstream of the adhesive strip, thus generating a tail edge of the first web material; and
dragging the second web material into a feed path by means of the tail edge of the first web material.

20. The method of claim 19, wherein the adhesive is selected from the group comprising: a bulk adhesive, a liquid adhesive, a pasty adhesive, a hot melt adhesive.

21. The method of claim 19, wherein the step of applying the adhesive comprises the step of translating an adhesive dispensing member along a trajectory orthogonal to the feed path of the web material while dispensing the adhesive onto the leading edge of the second web material.

22. The method of claim 21, wherein the adhesive dispensing member is carried by a slide, and wherein the slide is translated along a guide transverse to the feed path of the web material through the splicer.

23. The method of claim 22, further comprising the step of transversely trimming the leading edge of the second web material by means of a cutting tool carried by the slide, through a movement of the slide along the transverse guide.
